(19) United States
(12) Patent Application Publication
(10) Pub. No.: US 2025/0236298 A1
(43) Pub. Date: Jul. 24, 2025

(54) DRIVING ASSISTANCE DEVICE, DRIVING ASSISTANCE METHOD, AND NON-TRANSITORY RECORDING MEDIUM

(71) Applicant: TOYOTA JIDOSHA KABUSHIKI KAISHA, Toyota-shi Aichi-ken (JP)

(72) Inventors: Yizhou Fan, Suginami-ku Tokyo-to (JP); Tsubasa Imoto, Koto-ku Tokyo-to (JP)

(73) Assignee: TOYOTA JIDOSHA KABUSHIKI KAISHA, Toyota-shi Aichi-ken (JP)

(21) Appl. No.: 19/028,355

(22) Filed: Jan. 17, 2025

(30) Foreign Application Priority Data
Jan. 23, 2024 (JP) 2024-008275

(51) Int. Cl. B60W 30/18; B60Q 1/34; B60W 10/18; B60W 10/20

(52) U.S. Cl. CPC B60W 30/18163; B60Q 1/346; B60W 10/20; B60W 10/18; B60W 2552/53

(57) ABSTRACT

A driving assistance device acquires the information showing that a host vehicle is departing from a lane, information showing the lane in which the host vehicle is traveling, and information showing a recommended lane which a navigation device recommends at the time of performing route guidance, determines whether a lane departure of the host vehicle is an intentional lane departure by a driver of the host vehicle when the information showing that the host vehicle is departing from the lane is acquired, and determines that the lane departure of the host vehicle is the intentional lane departure by the driver of the host vehicle when the lane in which the host vehicle is traveling and the recommended lane are different.

### CROSS-REFERENCE TO RELATED APPLICATIONS

This application claims priority to Japanese Patent Application No. 2024-008275 filed Jan. 23, 2024, the entire contents of which are herein incorporated by reference.

### FIELD

The present disclosure relates to driving assistance device, driving assistance method, and non-transitory recording medium.

### BACKGROUND

PTL 1 (Japanese Unexamined Patent Publication No. 2015-102891) describes the art of providing an alert by a content corresponding to an operating state when a vehicle is departing from a lane. In the art described in PTL 1, when lane departure direction and blinker direction are the same, it is determined to be an intentional action of a driver.

In the art described in PTL 1, for example, when a lane in which a host vehicle is traveling and a recommended lane which a navigation device recommends at the time of performing route guidance are different, if the driver of the host vehicle performs a lane change of the host vehicle from the lane in which the host vehicle is traveling to the recommended lane without turning on a blinker, it is liable to end up being determined that the lane departure is not intended by the driver. The art in which when the driver of the host vehicle performs the lane change of the host vehicle from the lane in which the host vehicle is traveling to the recommended lane without turning on the blinker, it is determined that the lane departure is the intentional lane departure by the driver of the host vehicle and suitable driving assistance is performed is desired.

### SUMMARY

Considering the above-mentioned point, the present disclosure has as its object the provision of driving assistance device, driving assistance method, and non-transitory recording medium which can suitably determine whether the lane departure is the intentional lane departure by the driver of the host vehicle.
(1) One aspect of the present disclosure is a driving assistance device including a processor configured to: acquire information showing that a host vehicle is departing from a lane, information showing the lane in which the host vehicle is traveling, and information showing a recommended lane which a navigation device recommends at the time of performing route guidance; determine whether a lane departure of the host vehicle is an intentional lane departure by a driver of the host vehicle when the information showing that the host vehicle is departing from the lane is acquired; and determine that the lane departure of the host vehicle is the intentional lane departure by the driver of the host vehicle when the lane in which the host vehicle is traveling and the recommended lane are different.
(2) In the driving assistance device of the aspect (1), the processor be configured to determine that the lane departure of the host vehicle is the intentional lane departure by the driver of the host vehicle when the lane in which the host vehicle is traveling is right turn lane or left turn lane and the recommended lane is a straight lane.
(3) In the driving assistance device of the aspect (1) or (2), the processor may be configured to determine that the lane departure of the host vehicle is the intentional lane departure by the driver of the host vehicle when the lane in which the host vehicle is traveling is a straight lane and the recommended lane is right turn lane or left turn lane.
(4) In the driving assistance device of any one of the aspects (1) to (3), the processor may be configured to determine that the lane departure of the host vehicle is the intentional lane departure by the driver of the host vehicle when a direction of a branch lane of a junction in which the host vehicle is traveling and the direction of the recommended lane are different.
(5) In the driving assistance device according to any of the aspects (1) to (4), the processor may be configured to perform driving assistance for a lane change of the host vehicle when it is determined that the lane departure of the host vehicle is the intentional lane departure by the driver of the host vehicle.
(6) In the driving assistance device according to any one of the aspects (1) to (5), the processor may be configured to perform control to turn on a blinker automatically without the need for an operation by the driver of the host vehicle.
(7) In the driving assistance device according to any one of the aspects (1) to (6), the processor may be configured to perform control for making an HMI output an alert showing the lane departure of the host vehicle.
(8) In the driving assistance device according to any one of the aspects (1) to (7), the processor may be configured to determine that the lane departure of the host vehicle is the intentional lane departure by the driver of the host vehicle when the direction of the lane in which the host vehicle is traveling is opposite to the direction of the recommended lane.
(9) In the driving assistance device according to any one of the aspects (1) to (8), the processor may be configured to perform steering assistance for suppressing the lane department of the host vehicle when it is determined that the lane departure of the host vehicle is the intentional lane departure by the driver of the host vehicle.
(10) In the driving assistance device according to any one of the aspects (1) to (9), the processor may be configured to perform control for making an HMI output an alert showing the lane departure of the host vehicle when it is determined that the lane departure of the host vehicle is the intentional lane departure by the driver of the host vehicle.
(11) Another aspect of the present disclosure is a driving assistance method including: acquiring information showing that a host vehicle is departing from a lane, information showing the lane in which the host vehicle is traveling, and information showing a recommended lane which a navigation device recommends at the time of performing route guidance; determining whether a lane departure of the host vehicle is an intentional lane departure by a driver of the host vehicle when the information showing that the host vehicle is departing from the lane is acquired; and determining that the lane departure of the host vehicle is the intentional lane departure by the driver of the host vehicle when the lane in which the host vehicle is traveling and the recommended lane are different.
(12) Another aspect of the present disclosure is a non-transitory recording medium having recorded thereon a computer program for causing a processor to perform a process including: acquiring information showing that a host vehicle is departing from a lane, information showing the lane in which the host vehicle is traveling, and information showing a recommended lane which a navigation device recommends at the time of performing route guidance; determining whether a lane departure of the host vehicle is an intentional lane departure by a driver of the host vehicle when the information showing that the host vehicle is departing from the lane is acquired; and determining that the lane departure of the host vehicle is the intentional lane departure by the driver of the host vehicle when the lane in which the host vehicle is traveling and the recommended lane are different.

According to the present disclosure, it is possible to suitably determine whether the lane departure is the intentional lane departure by the driver of the host vehicle.

### BRIEF DESCRIPTION OF DRAWINGS

FIG. 1 is a view showing one example of a host vehicle 1 to which a driving assistance device 17 of a first embodiment is applied.

FIG. 2 is a view showing a first example of a lane TL in which the host vehicle 1 is traveling, a recommended lane RL which a navigation device 16 recommends at the time of performing route guidance, etc.

FIG. 3 is a view showing a second example of the lane TL in which the host vehicle 1 is traveling, the recommended lane RL which the navigation device 16 recommends at the time of performing the route guidance, etc.

FIG. 4 is a view showing a third example of the lane TL in which the host vehicle 1 is traveling, the recommended lane RL which the navigation device 16 recommends at the time of performing the route guidance, etc.

FIG. 5 is a view showing a fourth example of the lane TL in which the host vehicle 1 is traveling, the recommended lane RL which the navigation device 16 recommends at the time of performing the route guidance, etc.

FIG. 6 is a flowchart for explaining one example of a process performed by a processor 173 of the driving assistance device 17 of the first embodiment when the navigation device 16 performs the route guidance.

FIG. 7 is a flowchart for explaining one example of the process performed by the processor 173 of the driving assistance device 17 of a second embodiment when the navigation device 16 performs the route guidance.

FIG. 8 is a view for explaining one example of a direction in which the lane TL in which the host vehicle 1 is traveling extends and the direction in which the recommended lane RL extends.

FIG. 9 is a flowchart for explaining one example of the process performed by the processor 173 of the driving assistance device 17 of a fourth embodiment when the navigation device 16 performs the route guidance.

FIG. 10 is a view showing a fifth example of the lane TL in which the host vehicle 1 is traveling, the recommended lane RL which the navigation device 16 recommends at the time of performing route guidance, etc.

FIG. 11 is a flowchart for explaining one example of the process performed by the processor 173 of the driving assistance device 17 of a fifth embodiment when the navigation device 16 performs the route guidance.

### DESCRIPTION OF EMBODIMENTS

Below, referring to the drawings, embodiments of driving assistance device, driving assistance method, and non-transitory recording medium of the present disclosure will be explained.

### First Embodiment

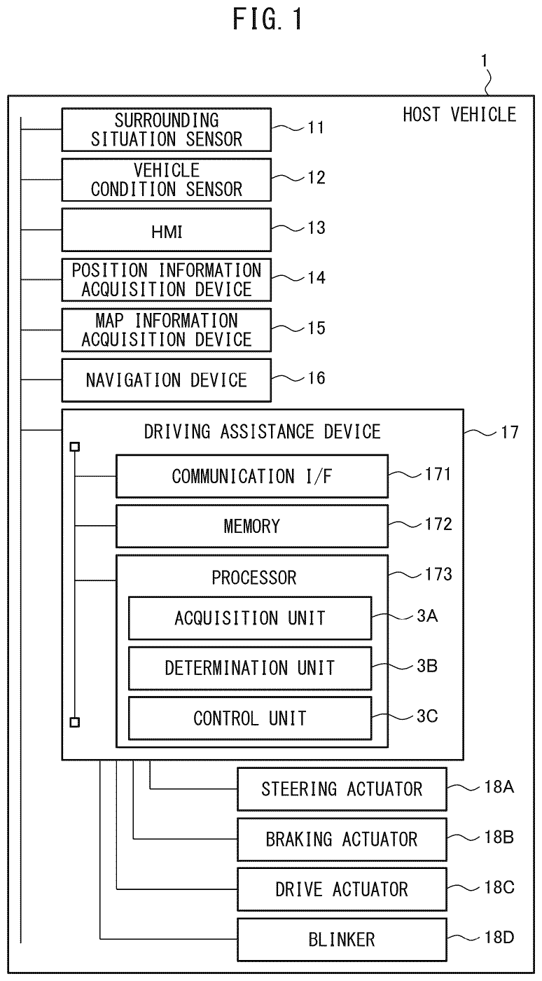

FIG. 1 is a view showing one example of a host vehicle 1 to which a driving assistance device 17 of a first embodiment is applied.

In the example shown in FIG. 1, the host vehicle 1 is provided with surrounding situation sensor 11, vehicle condition sensor 12, HMI (human machine interface) 13, position information acquisition device 14, map information acquisition device 15, navigation device 16, driving assistance device 17, steering actuator 18A, braking actuator 18B, drive actuator 18C, and blinker 18D.

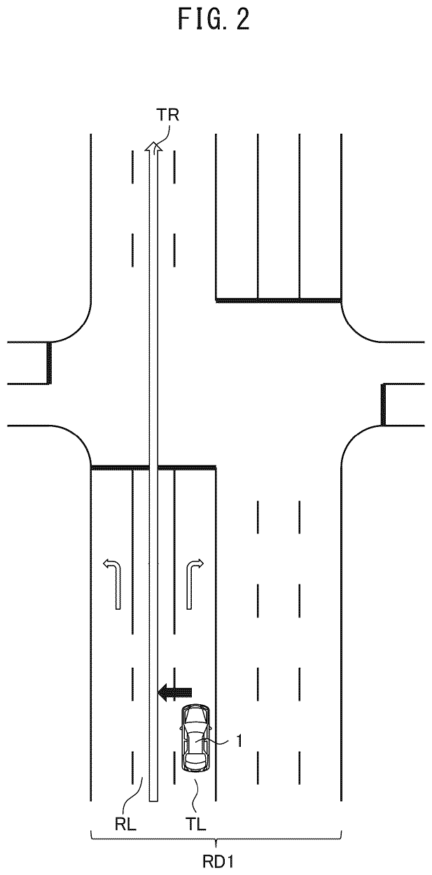

The surrounding situation sensor 11 detects a surrounding situation of the host vehicle 1 (for example, compartment line defining a lane TL (see FIG. 2) in which the host vehicle 1 is traveling, surrounding vehicle existing in the vicinity of the host vehicle 1, structures existing in the vicinity of the host vehicle 1, and the like) and sends the result of detection to the driving assistance device 17. The surrounding situation sensor 11 includes, for example, camera shooting the front and the like of the host vehicle 1, LiDAR (Light Detection And Ranging), or the like.

The vehicle condition sensor 12 detects condition of the host vehicle 1 and sends the result of detection to the driving assistance device 17. The vehicle condition sensor 12, for example, includes speed sensor, acceleration sensor, or the like.

The HMI 13 has the function of receiving various operations by a driver of the host vehicle 1, the function of outputting an alert by display, voice, etc. to the driver of the host vehicle 1, etc. and sends signals showing the operations by the driver of the host vehicle 1 to the driving assistance device 17 (sends information showing that the operations by the driver of the host vehicle 1 are received to the driving assistance device 17).

The position information acquisition device 14 acquires the information showing the position of the host vehicle 1. The position information acquisition device 14, for example, includes GPS (global positioning system) device or the like for measuring the position of the host vehicle 1. The position information acquisition device 14 may perform the well known process for estimating self-position (localization) and raise the precision of the information showing the position of the host vehicle 1. The position information acquisition device 14 sends the information showing the position of the host vehicle 1 to the navigation device 16, the driving assistance device 17, etc.

The map information acquisition device 15 acquires map information from a map database and sends the map information to the navigation device 16, the driving assistance device 17, etc. The map database may be stored in a storage device (not shown) mounted in the host vehicle 1 or may be stored in a management server at the outside of the host vehicle 1. In an example where the map database is stored in the management server at the outside of the host vehicle 1, the map information acquisition device 15 acquires the map information from the map database through communication between the host vehicle 1 and the management server.

In the example shown in FIG. 1, the navigation device 16 performs guidance up to a destination set by the driver of the host vehicle 1 through the HMI 13. The navigation device 16 calculates a target route TR (see FIG. 2) up to the destination based on the position information of the host vehicle 1 acquired by the position information acquisition device 14 and the map information acquired by the map information acquisition device 15 and provides navigation information relating to this target route TR to the driver of the host vehicle 1 through the HMI 13.

Further, the navigation device 16 has the function of determining a recommended lane RL (see FIG. 2) recommended at the time of performing route guidance. In some embodiments, the recommended lane RL is a lane in which the host vehicle 1 travels so as to travel along the target route TR up to the destination at the time of performing the route guidance, the recommended lane RL is included in a plurality of lanes included in a road RD1 (see FIG. 2) on which the host vehicle 1 is traveling.

The driving control device 17 is configured by for example a driving assistance ECU (electronic control unit) etc. The driving assistance device 17 is configured by a microcomputer provided with communication interface (I/F) 171, memory 172, and processor 173. The communication interface 171 has an interface circuit for connecting the driving assistance device 17 to the surrounding situation sensor 11, the vehicle condition sensor 12, the HMI 13, the position information acquisition device 14, the map information acquisition device 15, the navigation device 16, the steering actuator 18A, the braking actuator 18B, the drive actuator 18C, and the blinker 18D. The memory 172 stores a program used in a process performed by the processor 173 and various data. The processor 173 has the function as an acquisition unit 3A, the function as a determination unit 3B, and the function as a control unit 3C.

The acquisition unit 3A acquires the result of detection of the surrounding situation sensor 11 (for example, images of the front and the like of the host vehicle 1 shot by the camera, the result of detection of the LiDAR, etc.) and estimates the lane TL in which the host vehicle 1 is traveling based on the result of detection of the surrounding situation sensor 11. That is, the acquisition unit 3A acquires the information showing the lane TL in which the host vehicle 1 is traveling (the result of detection of the surrounding situation sensor 11).

Further, the acquisition unit 3A acquires the result of detection of the surrounding situation sensor 11 and estimates whether the host vehicle 1 is departing from the lane TL in which the host vehicle 1 is traveling based on the result of detection of the surrounding situation sensor 11. That is, the acquisition unit 3A acquires the information showing that the host vehicle 1 is departing from the lane (the result of detection of the surrounding situation sensor 11) when the acquisition unit 3A estimates that the host vehicle 1 is departing from the lane TL in which the host vehicle 1 is traveling.

Furthermore, the acquisition unit 3A acquires the information showing the target route TR up to the destination calculated by the navigation device 16. In more detail, the acquisition unit 3A acquires the information showing the recommended lane RL which the navigation device 16 recommends at the time of performing the route guidance.

FIG. 2 is a view showing a first example of the lane TL in which the host vehicle 1 is traveling, the recommended lane RL which the navigation device 16 recommends at the time of performing the route guidance, etc.

In the example shown in FIG. 2, the lane TL in which the host vehicle 1 is traveling is a right turn lane, while the recommended lane RL which the navigation device 16 recommends at the time of performing the route guidance is a straight lane. The lane TL in which the host vehicle 1 is traveling and the recommended lane RL are different. For this reason, the driver of the host vehicle 1 noticing that the lane TL in which the host vehicle 1 is traveling and the recommended lane RL are different may perform a lane change of the host vehicle 1 from the lane TL in which the host vehicle 1 is traveling to the recommended lane RL (a lane departure of the host vehicle 1 from the lane TL in which the host vehicle 1 is traveling).

When the lane change of the host vehicle 1 from the lane TL in which the host vehicle 1 is traveling to the recommended lane RL is performed by the driver of the host vehicle 1 without the blinker 18D being turned on, if the alert showing that the host vehicle 1 is departing from the lane is simply output or steering assistance is performed for suppressing the lane departure of the host vehicle 1, since driving assistance to reach the destination set by the driver of the host vehicle 1 is not performed, it can be said that suitable driving assistance is not being performed.

Therefore, in the example shown in FIG. 1, the measure explained below is taken to perform suitable driving assistance.

Specifically, in the example shown in FIG. 1, the determination unit 3B determines whether the lane departure of the host vehicle 1 is an intentional lane departure by the driver of the host vehicle 1 when the information showing that the host vehicle 1 is departing from the lane (the result of detection of the surrounding situation sensor 11) is acquired by the acquisition unit 3A.

When, like in the example shown in FIG. 2, the lane TL in which the host vehicle 1 is traveling shown by the information acquired by the acquisition unit 3A and the recommended lane RL shown by the information acquired by the acquisition unit 3A are different, the determination unit 3B determines that the lane departure of the host vehicle 1 is the intentional lane departure by the driver of the host vehicle 1.

In more detail, when, like in the example shown in FIG. 2, the lane TL in which the host vehicle 1 is traveling shown by the information acquired by the acquisition unit 3A is the right turn lane and the recommended lane RL shown by the information acquired by the acquisition unit 3A is the straight lane, the determination unit 3B determines that the lane departure of the host vehicle 1 (lane change of host vehicle 1 from the right turn lane to the straight lane) is the intentional lane departure by the driver of the host vehicle 1.

In the example shown in FIG. 1, the control unit 3C controls the steering actuator 18A, the braking actuator 18B, the drive actuator 18C, and the blinker 18D based on, for example, the information (data and signals) transmitted from the surrounding situation sensor 11, the vehicle condition sensor 12, the HMI 13, the position information acquisition device 14, the map information acquisition device 15, and the navigation device 16.

Specifically, in the example shown in FIG. 1, when the determination unit 3B determines that the lane departure of the host vehicle 1 is the intentional lane departure by the driver of the host vehicle 1, the control unit 3C performs the driving assistance for the lane change of the host vehicle 1. In more detail, the control unit 3C performs control to turn on the blinker 18D automatically without the need for the operation by the driver of the host vehicle 1.

When, like in the example shown in FIG. 2, the intentional lane departure by the driver of the host vehicle 1 (lane change of the host vehicle 1 from the right turn lane to the straight lane) is performed, the control unit 3C performs the control to automatically turn on the blinker 18D showing the lane change to the lane (straight lane) at the left side of the host vehicle 1 without the need for the operation by the driver of the host vehicle 1.

For this reason, in the example shown in FIG. 2, even when the driver of the host vehicle 1 is slow to notice that the lane TL in which the host vehicle 1 is traveling and the recommended lane RL are different and cannot afford to perform the operation for turning on the blinker 18D showing the lane change to the lane (straight lane) at the left side of the host vehicle 1, it is possible to realize the safe lane change of the host vehicle 1 from the right turn lane to the straight lane.

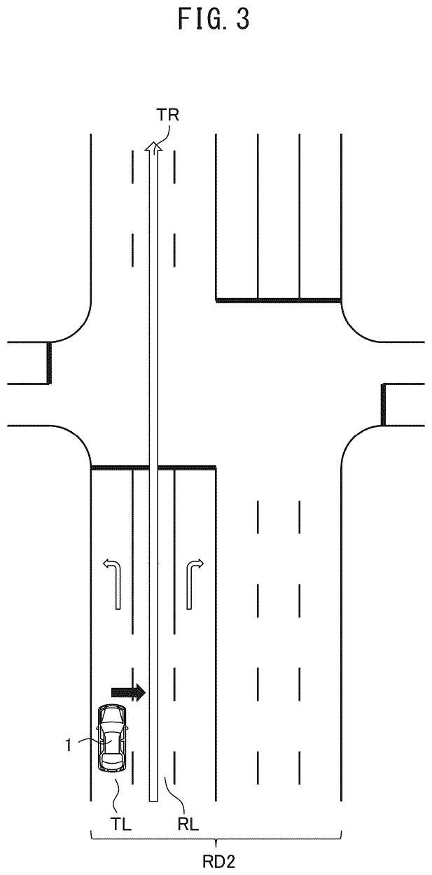

FIG. 3 is a view showing a second example of the lane TL in which the host vehicle 1 is traveling, the recommended lane RL which the navigation device 16 recommends at the time of performing the route guidance, etc.

In the example shown in FIG. 3, the road RD2 on which the host vehicle 1 is traveling includes the plurality of lanes, the lane TL in which the host vehicle 1 is traveling is a left turn lane, while the recommended lane RL which the navigation device 16 recommends at the time of performing the route guidance is the straight lane. The lane TL in which the host vehicle 1 is traveling and the recommended lane RL are different. For this reason, the driver of the host vehicle 1 noticing that the lane TL in which the host vehicle 1 is traveling and the recommended lane RL are different may perform the lane change of the host vehicle from the lane TL in which the host vehicle 1 is traveling to the recommended lane RL (lane departure of the host vehicle 1 from the lane TL in which the host vehicle 1 is traveling).

When, like in the example shown in FIG. 3, the lane TL in which the host vehicle 1 is traveling shown by the information acquired by the acquisition unit 3A and the recommended lane RL shown by the information acquired by the acquisition unit 3A are different, the determination unit 3B determines that the lane departure of the host vehicle 1 is the intentional lane departure by the driver of the host vehicle 1.

In more detail, when, like in the example shown in FIG. 3, the lane TL in which the host vehicle 1 is traveling shown by the information acquired by the acquisition unit 3A is the left turn lane and the recommended lane RL shown by the information acquired by the acquisition unit 3A is the straight lane, the determination unit 3B determines that the lane departure of the host vehicle 1 (lane change of the host vehicle 1 from the left turn lane to the straight lane) is the intentional lane departure by the driver of the host vehicle 1.

When, like in the example shown in FIG. 3, the intentional lane departure by the driver of the host vehicle 1 (lane change of the host vehicle 1 from the left turn lane to the straight lane) is performed, the control unit 3C performs the control to automatically turn on the blinker 18D showing the lane change to the lane (straight lane) at the right of the host vehicle 1 without the need for the operation by the driver of the host vehicle 1.

For this reason, in the example shown in FIG. 3, even when the driver of the host vehicle 1 is slow to notice that the lane TL in which the host vehicle 1 is traveling and the recommended lane RL are different and cannot afford to perform the operation for turning on the blinker 18D showing the lane change to the lane (straight lane) at the right side of the host vehicle 1, it is possible to realize the safe lane change of the host vehicle 1 from the left turn lane to the straight lane.

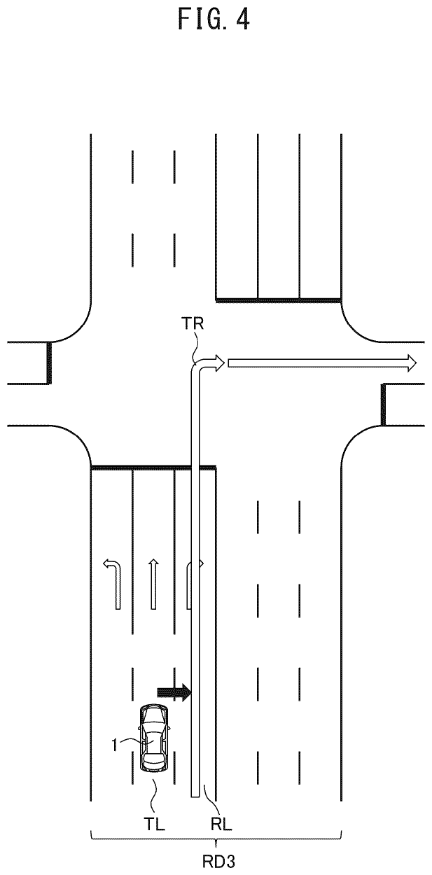

FIG. 4 is a view showing a third example of the lane TL in which the host vehicle 1 is traveling, the recommended lane RL which the navigation device 16 recommends at the time of performing the route guidance, etc.

In the example shown in FIG. 4, the road RD3 on which the host vehicle 1 is traveling includes the plurality of lanes, the lane TL in which the host vehicle 1 is traveling is the straight lane, while the recommended lane RL which the navigation device 16 recommends at the time of performing the route guidance is the right turn lane. The lane TL in which the host vehicle 1 is traveling and the recommended lane RL are different. For this reason, the driver of the host vehicle 1 noticing that the lane TL in which the host vehicle 1 is traveling and the recommended lane RL are different may perform the lane change of the host vehicle from the lane TL in which the host vehicle 1 is traveling to the recommended lane RL (lane departure of the host vehicle 1 from the lane TL in which the host vehicle 1 is traveling).

When, like in the example shown in FIG. 4, the lane TL in which the host vehicle 1 is traveling shown by the information acquired by the acquisition unit 3A and the recommended lane RL shown by the information acquired by the acquisition unit 3A are different, the determination unit 3B determines that the lane departure of the host vehicle 1 is the intentional lane departure by the driver of the host vehicle 1.

In more detail, when, like in the example shown in FIG. 4, the lane TL in which the host vehicle 1 is traveling shown by the information acquired by the acquisition unit 3A is the straight lane and the recommended lane RL shown by the information acquired by the acquisition unit 3A is the right turn lane, the determination unit 3B determines that the lane departure of the host vehicle 1 (lane change of the host vehicle 1 from the straight lane to the right turn lane) is the intentional lane departure by the driver of the host vehicle 1.

When, like in the example shown in FIG. 4, the intentional lane departure by the driver of the host vehicle 1 (lane change of the host vehicle 1 from the straight lane to the right turn lane) is performed, the control unit 3C performs the control to automatically turn on the blinker 18D showing the lane change to the lane (right turn lane) at the right side of the host vehicle 1 without the need for the operation by the driver of the host vehicle 1.

For this reason, in the example shown in FIG. 4, even when the driver of the host vehicle 1 is slow to notice that the lane TL in which the host vehicle 1 is traveling and the recommended lane RL are different and cannot afford to perform the operation for turning on the blinker 18D showing the lane change to the lane (right turn lane) at the right side of the host vehicle 1, it is possible to realize the safe lane change of the host vehicle 1 from the straight lane to the right turn lane.

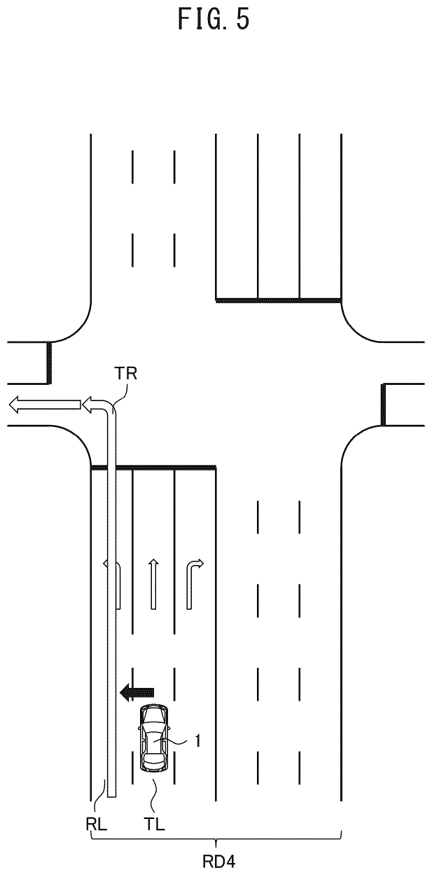

FIG. 5 is a view showing a fourth example of the lane TL in which the host vehicle 1 is traveling, the recommended lane RL which the navigation device 16 recommends at the time of performing the route guidance, etc.

In the example shown in FIG. 5, the road RD4 on which the host vehicle 1 is traveling includes the plurality of lanes, the lane TL in which the host vehicle 1 is traveling is the straight lane, while the recommended lane RL which the navigation device 16 recommends at the time of performing the route guidance is the left turn lane. The lane TL in which the host vehicle 1 is traveling and the recommended lane RL are different. For this reason, the driver of the host vehicle 1 noticing that the lane TL in which the host vehicle 1 is traveling and the recommended lane RL are different may perform the lane change of the host vehicle from the lane TL in which the host vehicle 1 is traveling to the recommended lane RL (lane departure of the host vehicle 1 from the lane TL in which the host vehicle 1 is traveling).

When, like in the example shown in FIG. 5, the lane TL in which the host vehicle 1 is traveling shown by the information acquired by the acquisition unit 3A and the recommended lane RL shown by the information acquired by the acquisition unit 3A are different, the determination unit 3B determines that the lane departure of the host vehicle 1 is the intentional lane departure by the driver of the host vehicle 1.

In more detail, when, like in the example shown in FIG. 5, the lane TL in which the host vehicle 1 is traveling shown by the information acquired by the acquisition unit 3A is the straight lane and the recommended lane RL shown by the information acquired by the acquisition unit 3A is the left turn lane, the determination unit 3B determines that the lane departure of the host vehicle 1 (lane change of the host vehicle 1 from the straight lane to the left turn lane) is the intentional lane departure by the driver of the host vehicle 1.

When, like in the example shown in FIG. 5, the intentional lane departure by the driver of the host vehicle 1 (lane change of the host vehicle 1 from the straight lane to the left turn lane) is performed, the control unit 3C performs the control to automatically turn on the blinker 18D showing the lane change to the lane (left turn lane) at the left side of the host vehicle 1 without the need for the operation by the driver of the host vehicle 1.

For this reason, in the example shown in FIG. 5, even when the driver of the host vehicle 1 is slow to notice that the lane TL in which the host vehicle 1 is traveling and the recommended lane RL are different and cannot afford to perform the operation for turning on the blinker 18D showing the lane change to the lane (left turn lane) at the left side of the host vehicle 1, it is possible to realize the safe lane change of the host vehicle 1 from the straight lane to the left turn lane.

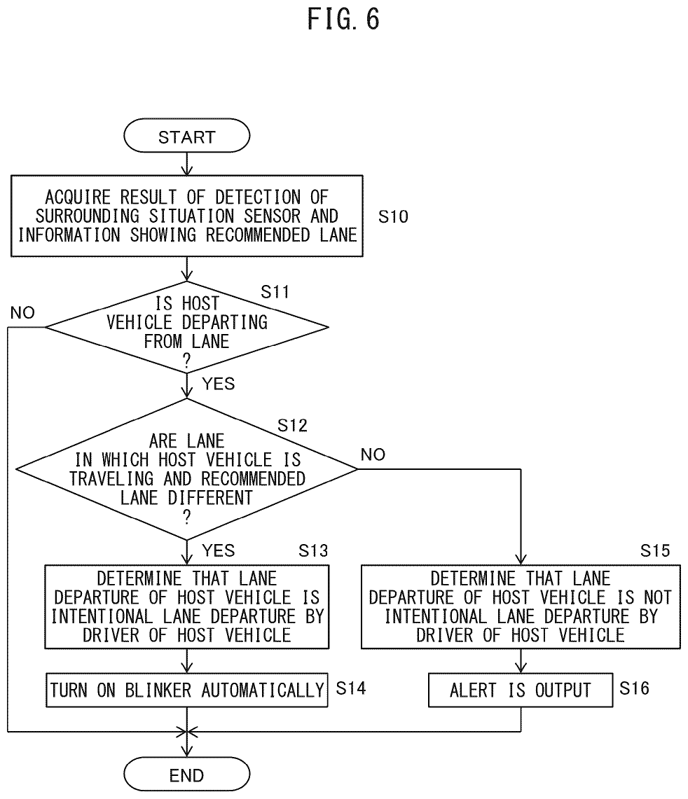

FIG. 6 is a flowchart for explaining one example of the process performed by the processor 173 of the driving assistance device 17 of the first embodiment when the navigation device 16 performs the route guidance.

In the example shown in FIG. 6, at step S10, the acquisition unit 3A acquires the result of detection of the surrounding situation sensor 11 and the information showing the recommended lane RL which the navigation device 16 recommends. In more detail, at step S10, the acquisition unit 3A estimates that the lane TL in which the host vehicle 1 is traveling based on the result of detection of the surrounding situation sensor 11.

At step S11, the acquisition unit 3A estimates whether the host vehicle 1 is departing from the lane TL in which the host vehicle 1 is traveling based on the result of detection of the surrounding situation sensor 11 acquired at step S10. When the acquisition unit 3A estimates that the host vehicle 1 is departing from the lane TL in which the host vehicle 1 is traveling, the routine proceeds to step S12, while when the acquisition unit 3A estimates that the host vehicle 1 is not departing from the lane TL in which the host vehicle 1 is traveling, the process shown in FIG. 6 is ended.

At step S12, for example, the determination unit 3B determines whether the lane TL in which the host vehicle 1 is traveling and the recommended lane RL are different. When YES, the routine proceeds to step S13, while when NO, the routine proceeds to step S15.

At step S13, the determination unit 3B determines that the lane departure of the host vehicle 1 is the intentional lane departure by the driver of the host vehicle 1.

At step S14, the control unit 3C performs the control to turn on the blinker 18D automatically without making the HMI 13 output the alert showing that the host vehicle 1 is departing from the lane.

At step S15, the determination unit 3B determines that the lane departure of the host vehicle 1 is not the intentional lane departure by the driver of the host vehicle 1.

At step S16, the control unit 3C makes the HMI 13 output the alert showing that the host vehicle 1 is departing from the lane.

### Second Embodiment

The host vehicle 1 to which the driving assistance device 17 of a second embodiment is applied is configured in the same way as the host vehicle 1 to which the driving assistance device 17 of the above-mentioned first embodiment is applied except for the points explained later.

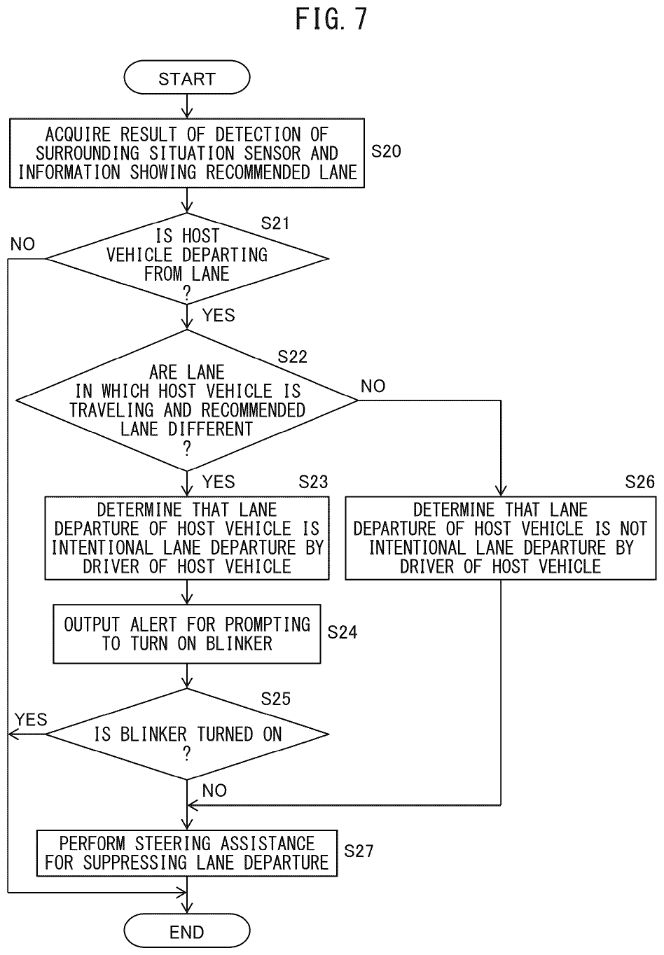

FIG. 7 is a flowchart for explaining one example of the process performed by the processor 173 of the driving assistance device 17 of the second embodiment when the navigation device 16 performs the route guidance.

In the example shown in FIG. 7, at step S20, the acquisition unit 3A acquires the result of detection of the surrounding situation sensor 11 and the information showing the recommended lane RL which the navigation device 16 recommends. In more detail, at step S20, the acquisition unit 3A estimates that the lane TL in which the host vehicle 1 is traveling based on the result of detection of the surrounding situation sensor 11.

At step S21, the acquisition unit 3A estimates whether the host vehicle is departing from the lane TL in which the host vehicle 1 is traveling based on the result of detection of the surrounding situation sensor 11 acquired at step S20. When the acquisition unit 3A estimates that the host vehicle 1 is departing from the lane TL in which the host vehicle 1 is traveling, the routine proceeds to step S22, while when the acquisition unit 3A estimates that the host vehicle 1 is not departing from the lane TL in which the host vehicle 1 is traveling, the process shown in FIG. 7 is ended.

At step S22, for example, the determination unit 3B determines whether the lane TL in which the host vehicle 1 is traveling and the recommended lane RL are different. When YES, the routine proceeds to step S23, while when NO, the routine proceeds to step S26.

At step S23, the determination unit 3B determines that the lane departure of the host vehicle 1 is the intentional lane departure by the driver of the host vehicle 1.

At step S24, the control unit 3C makes the HMI 13 output the alert for prompting the driver of the host vehicle 1 to turn on the blinker 18D.

At step S25, for example, the determination unit 3B determines whether the HMI 13 receives the operation by the driver of the host vehicle 1 to turn on the blinker 18D. In more detail, the determination unit 3B determines whether the acquisition unit 3A acquires the signal showing the operation by the driver of the host vehicle 1 to turn on the blinker 18D from the HMI 13. When YES, the process shown in FIG. 7 is ended, while when NO, the routine proceeds to step S27.

At step S26, the determination unit 3B determines that the lane departure of the host vehicle 1 is not the intentional lane departure by the driver of the host vehicle 1. Next, the routine proceeds to step S27.

At step S27, the control unit 3C performs the steering assistance for suppressing lane departure of the host vehicle 1. In more detail, the control unit 3C makes the steering actuator 18A operate without the need for the operation for input by the driver of the host vehicle 1 and suppresses the lane departure of the host vehicle 1.

### Third Embodiment

The host vehicle 1 to which the driving assistance device 17 of a third embodiment is applied is configured in the same way as the host vehicle 1 to which the driving assistance device 17 of the above-mentioned first embodiment is applied except for the points explained later.

As explained above, in the host vehicle 1 to which the driving assistance device 17 of the first embodiment is applied, the acquisition unit 3A acquires the result of detection of the surrounding situation sensor 11 (for example, images of the front and the like of the host vehicle 1 shot by the camera, the result of detection of the LiDAR, etc.) and estimates the lane TL in which the host vehicle 1 is traveling based on the result of detection of the surrounding situation sensor 11.

On the other hand, in the host vehicle 1 to which the driving assistance device 17 of the third embodiment is applied, the acquisition unit 3A acquires the information showing the position of the host vehicle 1 acquired by the position information acquisition device 14 and the map information acquired by the map information acquisition device 15 from the map database and estimates the lane TL in which the host vehicle 1 is traveling based on the information showing the position of the host vehicle 1 and the map information.

### Fourth Embodiment

The host vehicle 1 to which the driving assistance device 17 of a fourth embodiment is applied is configured in the same way as the host vehicle 1 to which the driving assistance device 17 of the above-mentioned first embodiment is applied except for the points explained later.

In one example of the host vehicle 1 to which the driving assistance device 17 of the fourth embodiment is applied, the surrounding situation sensor 11 detects the direction in which the lane TL in which the host vehicle 1 is traveling extends and sends the result of detection to the driving assistance device 17. The acquisition unit 3A acquires the result of detection of the surrounding situation sensor 11 (information showing the direction in which the lane TL in which the host vehicle 1 is traveling extends). The navigation device 16 calculates the direction in which the recommended lane RL extends based on the map information acquired by the map information acquisition device 15 and sends the result of calculation to the driving assistance device 17. The acquisition unit 3A acquires the result of calculation of the navigation device 16 (information showing the direction in which the recommended lane RL extends).

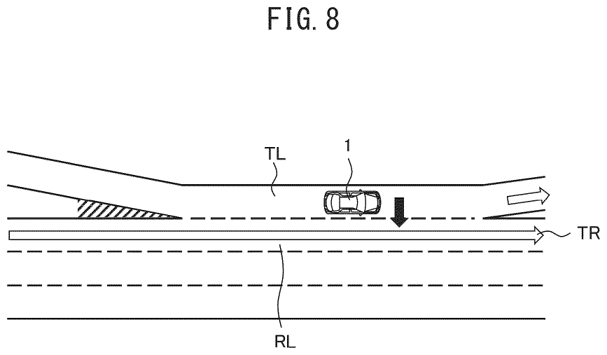

FIG. 8 is a view for explaining one example of the direction in which the lane TL in which the host vehicle 1 is traveling extends and the direction in which the recommended lane RL extends.

In the example shown in FIG. 8, the host vehicle 1 is traveling in a branch lane of a junction. That is, the lane TL in which the host vehicle 1 is traveling is the branch lane of the junction. The branch lane of the junction (the lane TL in which the host vehicle 1 is traveling) extends toward the top right of FIG. 8. On the other hand, the recommended lane RL extends toward the right in FIG. 8.

In the example of the host vehicle 1 to which the driving assistance device 17 of the fourth embodiment is applied, like in the example shown in FIG. 8, when the direction of the branch lane (the lane TL in which the host vehicle 1 is traveling) of the junction in which the host vehicle 1 is traveling and the direction of the recommended lane RL are different, the determination unit 3B determines that the lane departure of the host vehicle 1 (the lane change of the host vehicle 1 from the lane TL in which the host vehicle 1 is traveling to the recommended lane RL) is the intentional lane departure by the driver of the host vehicle 1.

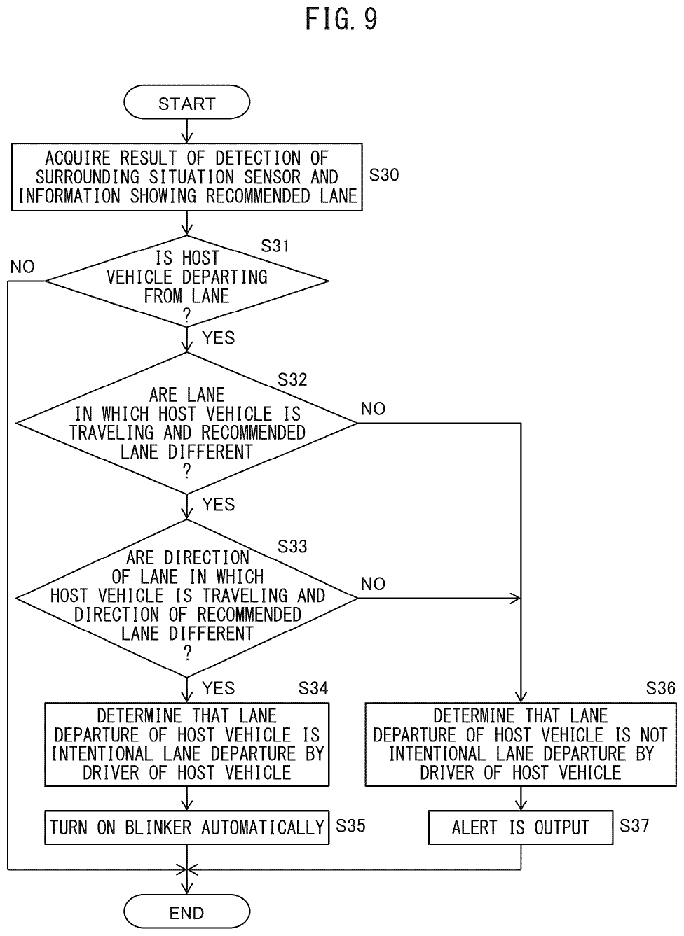

FIG. 9 is a flowchart for explaining one example of the process performed by the processor 173 of the driving assistance device 17 of the fourth embodiment when the navigation device 16 performs the route guidance.

In the example shown in FIG. 9, at step S30, the acquisition unit 3A acquires the result of detection of the surrounding situation sensor 11 (information showing the direction in which the lane TL (branch lane) in which the host vehicle 1 is traveling extends etc.) and the information showing the recommended lane RL which the navigation device 16 recommends (information showing the direction in which the recommended lane RL extends etc.)

At step S31, the acquisition unit 3A estimates whether the host vehicle 1 is departing from the lane TL (branch lane) in which the host vehicle 1 is traveling based on the result of detection of the surrounding situation sensor 11 acquired at step S30. When the acquisition unit 3A estimates that the host vehicle 1 is departing from the lane TL (branch lane) in which the host vehicle 1 is traveling, the routine proceeds to step S32, while when the acquisition unit 3A estimates that the host vehicle 1 is not departing from the lane TL (branch lane) in which the host vehicle 1 is traveling, the process shown in FIG. 9 is ended.

At step S32, for example, the determination unit 3B determines whether the lane TL (branch lane) in which the host vehicle 1 is traveling and the recommended lane RL are different. When YES, the routine proceeds to step S33, while when NO, the routine proceeds to step S36.

At step S33, for example the determination unit 3B determines whether the direction of the lane TL (branch lane) in which the host vehicle 1 is traveling and the direction of the recommended lane RL are different. When YES (like in the example shown in FIG. 8, when the direction in which the lane TL (branch lane) in which the host vehicle 1 is traveling extends and the direction of the recommended lane RL are different), the routine proceeds to step S34, while when NO, the routine proceeds to step S36.

At step S34, the determination unit 3B determines that the lane departure of the host vehicle 1 is the intentional lane departure by the driver of the host vehicle 1.

At step S35, the control unit 3C performs the control to turn on the blinker 18D automatically without making the HMI 13 output the alert showing that the host vehicle 1 is departing from the lane.

At step S36, the determination unit 3B determines that the lane departure of the host vehicle 1 is not the intentional lane departure by the driver of the host vehicle 1.

At step S37, the control unit 3C makes the HMI 13 output the alert showing that the host vehicle 1 is departing from the lane.

### Fifth Embodiment

The host vehicle 1 to which the driving assistance device 17 of a fifth embodiment is applied is configured in the same way as the host vehicle 1 to which the driving assistance device 17 of the above-mentioned first embodiment is applied except for the points explained later.

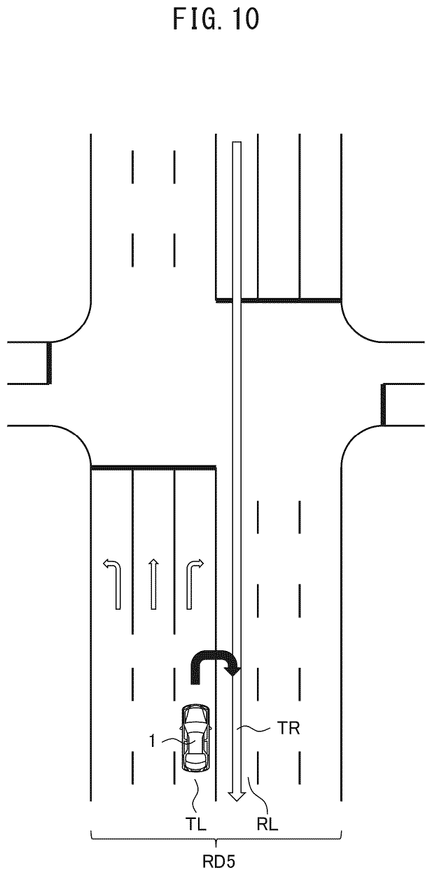

FIG. 10 is a view showing a fifth example of the lane TL in which the host vehicle 1 is traveling on the road RD5, the recommended lane RL which the navigation device 16 recommends at the time of performing the route guidance, etc.

In the example shown in FIG. 10, the direction (upward in FIG. 10) of the lane TL in which the host vehicle 1 is traveling is opposite to the direction (downward in FIG. 10) of the recommended lane RL which the navigation device 16 recommends at the time of performing the route guidance. That is, the lane TL in which the host vehicle 1 is traveling and the recommended lane RL are different. For this reason, the driver of the host vehicle 1 noticing that the direction of the lane TL in which the host vehicle 1 is traveling is opposite to the direction of the recommended lane RL may perform a U-turn for the host vehicle 1 (that is, perform the lane change of the host vehicle 1 from the lane TL in which the host vehicle 1 is traveling to the recommended lane RL (in other words, perform the lane departure of the host vehicle 1 from the lane TL in which the host vehicle 1 is traveling)).

When the U-turn (lane change) of the host vehicle 1 from the lane TL in which the host vehicle 1 is traveling to the recommended lane RL is performed by the driver of the host vehicle 1 without the blinker 18D being turned on, if the alert showing that the host vehicle 1 is departing from the lane is simply output or the steering assistance is performed for suppressing the lane departure (U-turn) of the host vehicle 1, since the driving assistance to reach the destination set by the driver of the host vehicle 1 is not performed, it can be said that suitable driving assistance is not being performed.

Therefore, in one example of the host vehicle 1 to which the driving assistance device 17 of the fifth embodiment is applied, the measure explained below is taken to perform suitable driving assistance.

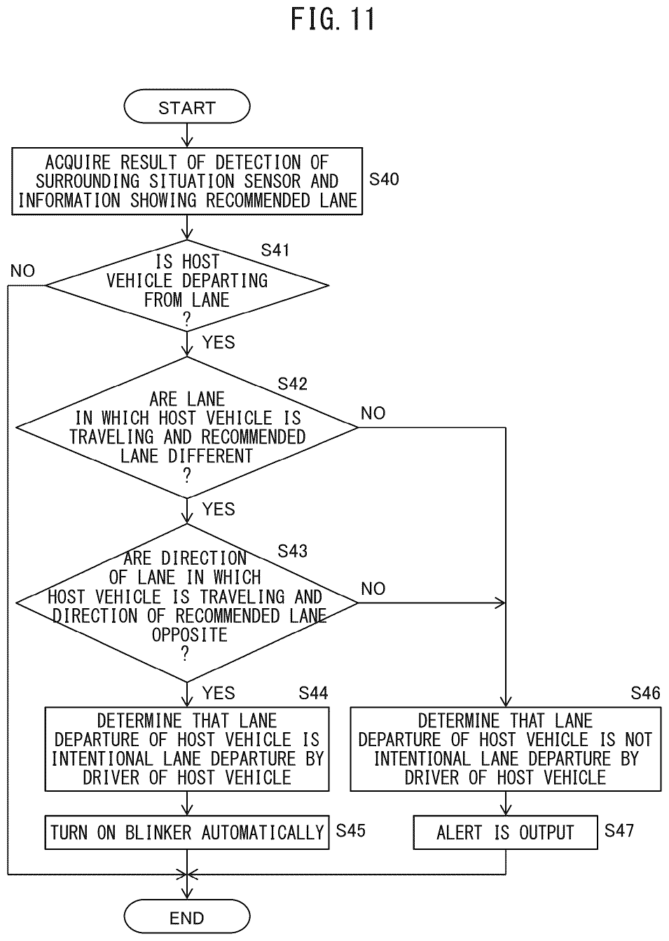

FIG. 11 is a flowchart for explaining one example of the process performed by the processor 173 of the driving assistance device 17 of the fifth embodiment when the navigation device 16 performs the route guidance.

In the example shown in FIG. 11, at step S40, the acquisition unit 3A acquires the result of detection of the surrounding situation sensor 11 (the direction of the lane TL in which the host vehicle 1 is traveling etc.) and the information showing the recommended lane RL which the navigation device 16 recommends (information showing the direction of the recommended lane RL etc.)

At step S41, the acquisition unit 3A estimates whether the host vehicle 1 is departing from the lane TL in which the host vehicle 1 is traveling based on the result of detection of the surrounding situation sensor 11 acquired at step S40. When the acquisition unit 3A estimates that the host vehicle is departing from the lane TL in which the host vehicle 1 is traveling, the routine proceeds to step S42, while when the acquisition unit 3A estimates that the host vehicle is not departing from the lane TL in which the host vehicle 1 is traveling, the process shown in FIG. 11 is ended.

At step S42, for example, the determination unit 3B determines whether the lane TL in which the host vehicle 1 is traveling and the recommended lane RL are different. When YES, the routine proceeds to step S43, while when NO, the routine proceeds to step S46.

At step S43, for example, the determination unit 3B determines whether the direction of the lane TL in which the host vehicle 1 is traveling is opposite to the direction of the recommended lane RL. When YES, (when the direction of the lane TL in which the host vehicle 1 is traveling is opposite to the direction of the recommended lane RL like in the example shown in FIG. 10), the routine proceeds to step S44, while when NO, the routine proceeds to step S46.

At step S44, the determination unit 3B determines that the lane departure of the host vehicle 1 is the intentional lane departure by the driver of the host vehicle 1.

At step S45, the control unit 3C performs the control to turn on the blinker 18D automatically without making the HMI 13 output the alert showing that the host vehicle 1 is departing from the lane.

At step S46, the determination unit 3B determines that the lane departure of the host vehicle 1 is not the intentional lane departure by the driver of the host vehicle 1.

At step S47, the control unit 3C makes the HMI 13 output the alert showing that the host vehicle 1 is departing from the lane.

In another example, at step S47, the control unit 3C may perform the steering assistance for suppressing the lane departure of the host vehicle 1.

In still another example, at step S47, the control unit 3C may perform the steering assistance for suppressing the lane departure of the host vehicle 1 and make the HMI 13 output the alert showing that the host vehicle 1 is departing from the lane.

As explained above, although the embodiments of the driving assistance device, the driving assistance method, and the non-transitory recording medium of the present disclosure were explained with reference to the drawings, the driving assistance device, the driving assistance method, and the non-transitory recording medium of the present disclosure are not limited to the above-mentioned embodiments and may be suitably changed without departing from the gist of the present disclosure. The constitutions of each example of the embodiment explained above may be suitably combined. In each example of the embodiment explained above, the process performed in the driving assistance device 17 was explained as software process performed by executing the program, but the process performed in the driving assistance device 17 may also be the process performed by hardware. Alternatively, the process performed in the driving assistance device 17 may be the process combining both software and hardware. Further, the program (program for realizing the function of the processor 173 of the driving assistance device 17) stored in the memory 172 of the driving assistance device 17 may, for example, be recorded in a computer readable storage medium (non-transitory recording medium) such as semiconductor memory, magnetic recording medium, optical recording medium, or the like and supplied, distributed, etc.

1. A driving assistance device comprising a processor configured to:
acquire information showing that a host vehicle is departing from a lane, information showing the lane in which the host vehicle is traveling, and information showing a recommended lane which a navigation device recommends at the time of performing route guidance;
determine whether a lane departure of the host vehicle is an intentional lane departure by a driver of the host vehicle when the information showing that the host vehicle is departing from the lane is acquired; and
determine that the lane departure of the host vehicle is the intentional lane departure by the driver of the host vehicle when the lane in which the host vehicle is traveling and the recommended lane are different.

2. The driving assistance device according to claim 1, wherein the processor is configured to determine that the lane departure of the host vehicle is the intentional lane departure by the driver of the host vehicle when the lane in which the host vehicle is traveling is right turn lane or left turn lane and the recommended lane is a straight lane.

3. The driving assistance device according to claim 1, wherein the processor is configured to determine that the lane departure of the host vehicle is the intentional lane departure by the driver of the host vehicle when the lane in which the host vehicle is traveling is a straight lane and the recommended lane is right turn lane or left turn lane.

4. The driving assistance device according to claim 1, wherein the processor is configured to determine that the lane departure of the host vehicle is the intentional lane departure by the driver of the host vehicle when a direction of a branch lane of a junction in which the host vehicle is traveling and a direction of the recommended lane are different.

5. The driving assistance device according to claim 1, wherein the processor is configured to perform driving assistance for a lane change of the host vehicle when it is determined that the lane departure of the host vehicle is the intentional lane departure by the driver of the host vehicle.

6. The driving assistance device according to claim 5, wherein the processor is configured to perform control to turn on a blinker automatically without the need for an operation by the driver of the host vehicle.

7. The driving assistance device according to claim 5, wherein the processor is configured to perform control for making an HMI output an alert showing the lane departure of the host vehicle.

8. The driving assistance device according to claim 1, wherein the processor is configured to determine that the lane departure of the host vehicle is the intentional lane departure by the driver of the host vehicle when a direction of the lane in which the host vehicle is traveling is opposite to a direction of the recommended lane.

9. The driving assistance device according to claim 8, wherein the processor is configured to perform steering assistance for suppressing the lane department of the host vehicle when it is determined that the lane departure of the host vehicle is the intentional lane departure by the driver of the host vehicle.

10. The driving assistance device according to claim 9, wherein the processor is configured to perform control for making an HMI output an alert showing the lane departure of the host vehicle when it is determined that the lane departure of the host vehicle is the intentional lane departure by the driver of the host vehicle.

11. A driving assistance method comprising:
acquiring information showing that a host vehicle is departing from a lane, information showing the lane in which the host vehicle is traveling, and information showing a recommended lane which a navigation device recommends at the time of performing route guidance;
determining whether a lane departure of the host vehicle is an intentional lane departure by a driver of the host vehicle when the information showing that the host vehicle is departing from the lane is acquired; and
determining that the lane departure of the host vehicle is the intentional lane departure by the driver of the host vehicle when the lane in which the host vehicle is traveling and the recommended lane are different.

12. A non-transitory recording medium having recorded thereon a computer program for causing a processor to perform a process comprising:
acquiring information showing that a host vehicle is departing from a lane, information showing the lane in which the host vehicle is traveling, and information showing a recommended lane which a navigation device recommends at the time of performing route guidance;
determining whether a lane departure of the host vehicle is an intentional lane departure by a driver of the host vehicle when the information showing that the host vehicle is departing from the lane is acquired; and
determining that the lane departure of the host vehicle is the intentional lane departure by the driver of the host vehicle when the lane in which the host vehicle is traveling and the recommended lane are different.
